(19) United States
(12) Patent Application Publication
(10) Pub. No.: US 2004/0181470 A1
(43) Pub. Date: Sep. 16, 2004

(54) System, method, and computer program product for taxation of online transactions

(75) Inventor: Gavin A. Grounds, Plano, TX (US)

Correspondence Address: DOCKET CLERK, DM/EDS, P.O. DRAWER 800889, DALLAS, TX, 75380, US

(73) Assignee: Electronic Data Systems Corporation, Plano, TX

(21) Appl. No.: 10/636,305

(22) Filed: Aug. 7, 2003

Related U.S. Application Data
(60) Provisional application No. 60/453,874, filed on Mar. 11, 2003.

(51) Int. Cl. G06F 17/60

(52) U.S. Cl. 705/31

(57) ABSTRACT

A system, method, and computer program product for determining and collecting sales/use taxes across multiple jurisdictions that is particularly useful for internet and on-line transactions. Further, there is disclosed a system and method for online transactions, including purchases and refunds, that includes cross-jurisdictional sales/use tax determination and collection processes.

### CROSS-REFERENCE TO OTHER APPLICATION

This application claims priority from U.S. Provisional Patent Application 60/453,874, filed 11 Mar. 2003, which is hereby incorporated by reference.

### TECHNICAL FIELD OF THE INVENTION

The present invention is directed, in general, to the assessment and collection of taxes on online transactions.

### BACKGROUND OF THE INVENTION

The collection of sales tax, consumption tax (or “use tax”), as well as other sales-related taxes, for goods and services sold by electronic transactions, such has via the Internet and through wireless communications, has long been both a political debate and a challenge to define an appropriate technical, operational and governance models. Similarly, even before the proliferation of internet-based commerce, the appropriate taxation of remote sales across state and international borders, such as those conducted via the telephone, have presented a challenge to the taxing authorities to present an effective tax calculation and collection model. In the United States, there are a number of States that have already started to require that Sales tax be collected and remitted, even for “on-line” (i.e., primarily via the Internet) transactions, in particular when the merchant has a physical presence in the taxing jurisdiction even if the sale is made online from another location. This is true both of transactions that are conducted on line and where the goods or services are delivered electronically, as well as where delivery is of a physical nature and where transactions are conducted remotely, such as via the telephone.

In the United States, states are currently prohibited from imposing collection responsibilities when there is no physical connection with the vendor, though many states are working hard to have this policy changed.

Notwithstanding the political issues surrounding this subject, which are not addressed by the invention described herein, the technical, operational and governance challenges for an accurate collection and remittance model, are exponentially greater when one views the issue, not only from a U.S.A. perspective, but from an International perspective.

Recently, the government of the United Kingdom expressed its intent to require all merchants selling products & services on-line, to collect sales (or “consumption”) taxes and remit them to the UK Government's VAT department. It is now the case that all EU member countries plan to require merchants selling products and/or services into the EU, to collect and remit sales/use tax on products and services sold on line beginning in 2004.

There is, therefore, a need in the art for a system, and method, and computer program product for assessing and collecting cross-jurisdictional sales-related taxes.

### SUMMARY OF THE INVENTION

To address the above-discussed deficiencies of the prior art, it is an object of the present invention to provide a system and method for enabling persons to quickly and conveniently convert paper documents to electronic documents, to archive the electronic documents, and to retrieve and reproduce the electronic documents.

According to a preferred embodiment, there is a system and method for determining and collecting sales/use taxes across multiple jurisdictions that is particularly useful for internet, on-line and remote/telephone-based transactions. Further, there is disclosed a system and method for online transactions that includes cross-jurisdictional sales/use tax determination and collection processes.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a block diagram of a network system in accordance with a preferred embodiment;

FIG. 2 depicts a block diagram of a data processing system in accordance with a preferred embodiment;

FIG. 3 depicts a flowchart of a process in accordance with a preferred embodiment;

FIG. 4 depicts a flowchart of a process in accordance with a preferred embodiment;

FIG. 5 depicts a flowchart of a client validation process in accordance with a preferred embodiment of the present invention;

FIG. 6 depicts a flowchart of a merchant validation process in accordance with a preferred embodiment of the present invention;

FIG. 7 depicts a data/logic flow for establishing the tax jurisdiction(s) that has/have a claim over a given transaction, as well as the basis/bases for such claim.

FIG. 8 depicts a data/logic flow for resolving conflicting rules pertaining to the establishment of jurisdiction(s) that has/have a claim over a given transaction, as well as the basis/bases for such claim.

FIG. 9 depicts a tax settlement process in accordance with a preferred embodiment of the present invention;

FIG. 10 depicts a block diagram of a sample tax settlement in accordance with the preferred embodiment; and

FIG. 11 is a block diagram of means of updating a tax rules database in accordance with a preferred embodiment of the present invention.

### DETAILED DESCRIPTION OF THE INVENTION

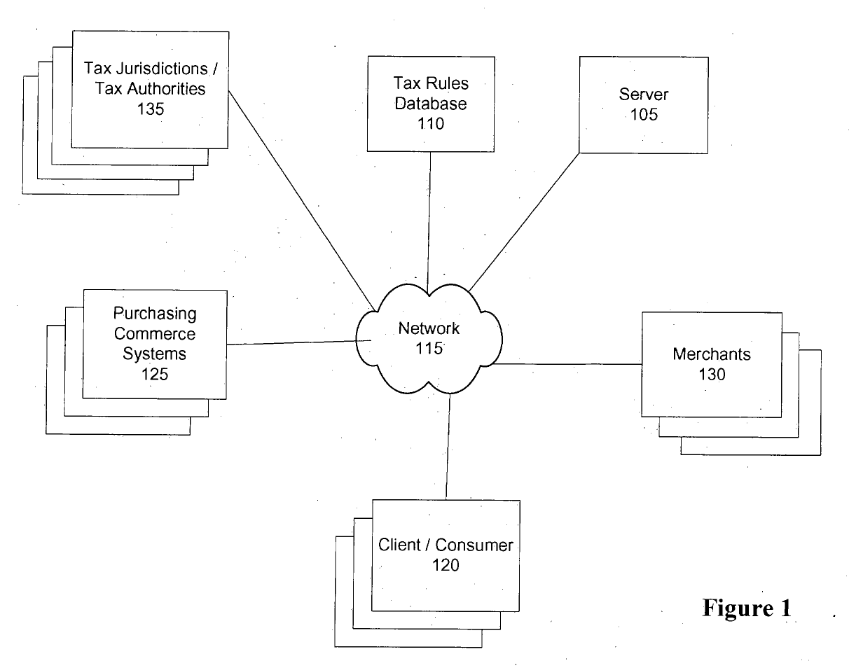

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

According to a preferred embodiment, there is a system and method for determining and collecting sales/use taxes across multiple jurisdictions that is particularly useful for internet and on-line transactions. Further, there is disclosed a system and method for online transactions, including purchases and refunds, that includes cross-jurisdictional sales/use tax determination and collection processes.

The problems involved in cross-jurisdictional sales/use taxation are detailed and extensive, but include establishment of jurisdiction for tax purposes. One of the first challenges addressed by the disclosed embodiments is to establish the tax jurisdiction(s), that is, the government(s) for whom the tax will be collected and to whom it will be remitted. There are two sub-elements to this problem, the first is identity management and the second is conflicting taxation rules. It should be noted that when the term “sales tax” or similar terms are used herein, it is understood to refer to sales taxes, use taxes, consumption taxes, and any similar taxes or fees.

Identity management becomes a challenge because, by nature, the Internet does not easily afford the parties to a transaction to readily identify themselves. Thus, it is not easy to clearly define which jurisdiction is applicable for the consumption tax. Similarly, some consumers have residency in multiple jurisdictions that may complicate the establishment of the tax jurisdiction. Finally, privacy laws and conflicting privacy laws & regulations from one jurisdiction to another and from one industry to another inhibit the ability to establish the tax jurisdiction for a given transaction.

Conflicting taxation rules are another challenge for an international cross-jurisdictional sales/use tax collection & remittance system. For example, one country may take the view that the jurisdiction is defined by the citizenship of the buyer. Another country may state that the jurisdiction is defined by the place of consumption of the product. Similarly, one government's rules may state that a given tax is based on the location of the merchant, whereas another's may state that the tax is defined by the location of the use by the buyer, or by the place of purchase. In scenarios such as these, there would be a direct conflict, as there would be at least two different jurisdictions claiming “ownership” of the sales/use taxes pertaining to the transaction.

Assuming that the establishment of jurisdiction issues have been addressed, the next area of the problem pertains to the calculation, collection and remittance of the sales/use taxes. Many countries have quite complex rules that apply to the rate of sales/use tax to be applied, exemption rules, product categorization rules (for example, differentiation between digital goods and services -v- physical goods.) Hence, calculation of the correct level of tax to be collected, if any, would a challenge for the merchant.

Collection and remittance of sales/use taxes in a cross-jurisdictional model, present a significant challenge, due to the burden that is placed on the merchant. If the merchants are made responsible for the collection and remittance of taxes to multiple jurisdictions, it is highly likely that the majority of merchants will decide to decline transactions that do not fall into their “local” jurisdiction. Conversely, if they accept the transactions, it will likely increase the overall costs involved to the merchant to participate in the digital economy.

Similarly, the process of remitting collected sales/use taxes to multiple authorities in multiple currencies and languages, will place a heavy burden on the merchants providing these services. In addition, there will be challenges identifying who absorbs the Foreign Exchange costs and risks. For example, if the merchant completes the transaction in US Dollars and submits the collected taxes one week later, the exchange rate between US$ and the destination government's currency may have changed, with potential adverse impact to the merchant.

Once a technical solution is available to manage the process of jurisdiction selection, calculation and remittance, technical implementation is still challenging. This is because, in today's e-commerce environment, the majority of Internet transactions are paid for by credit card, or by electronic funds transfer. The systems and processes that handle the collection of funds from the purchaser and settlement of the funds into the merchants' accounts are typically run by a third-party provider and are thus often out of the direct control of the merchant. Similarly, the web servers and product catalogue services are normally owned and operated by a third party.

Thus, if a merchant is required to collect and remit sales/use tax to multiple international agencies, the merchant might not be in a position to be able to implement the necessary systems and processes needed to facilitate such a requirement.

The final major area of challenge with a cross-jurisdictional sales/use taxation pertains to governance. Any government that introduces a policy that requires overseas (non-domestic) merchants to collect sales/use tax and remit sales/use tax on their behalf, will need to implement mechanisms to police/monitor/enforce such requirements.

Similarly, each merchant will need to understand the governance requirements from any international jurisdiction for which they will be required to collect and remit sales/use tax taxes.

This also presents a challenge pertaining to liabilities and cross-border/cross-jurisdictional compliance and litigation.

The embodiments disclosed herein provide all of the necessary means to address the issues described in the previous section. The system and method addresses the major elements of jurisdiction selection and individual identity, conflicting taxation rules management, remittance and refunds, and governance.

The various parties in any given transaction are described herein as discreet entities in of themselves, including, for example, the Buyer, Merchant, Payment Processor, Issuing Bank, Acquiring Bank, Sales Tax Processor, Collecting authority, etc. However, it is understood that any given company or organization may well perform multiple functions and be responsible for multiple roles in completing a transaction.

According to at least one disclosed embodiment, once the buyer has completed the product selection process, he/she is presented with the same “check-out” screen that would customarily be presented. At this point, the buyer is asked for information such as billing address, shipping address, payment method, etc. In the case of electronic content or services, the buyer is asked to confirm that the “Shipping Address” is the primary location where the product or service will be most often used.

Once these details have been submitted, the appropriate information is submitted to the payment-processing engine and to the Sales Tax Processing Suite (STPS). Note that, in some cases, product categorization data cannot be submitted to a payment processor. This could be submitted to the STPS, though, to allow for the application of the correct sales/use tax rate(s). The STPS will create a unique transaction identifier for the transaction. Based on rules that have been previously provided by the various sales/use tax collection agencies, the STPS will select which jurisdiction(s) is/are to be applied to the transaction.

In parallel to this, the payment engine will be communicating with an authorizing third-party that is able to ratify the claimed residency and location-related information of both the buyer and the merchant. In one embodiment, this could be the financial organization that the buyer has selected to authorize the payment and/or the merchant's bank. This can be a credit card issuer, a bank or other financial services provider, but will be referred to herein generically as “the bank.” Where possible and permitted by law & regulations, the residency, or the claimed residency, of the buyer and the merchant will also be confirmed. Subsequently, pertinent data connected with the establishment of sales/use tax jurisdiction will be passed back to the STPS by the payment processor, or directly from the bank.

Based on the collected data, the STPS applies the most appropriate sales/use tax jurisdiction, calculates the appropriate tax to be collected and passes this data to the payment-processing suite.

The buyer is asked to authorize the transaction. In doing so, the buyer is preferably advised as to which jurisdiction(s) if any, will be receiving the collected sales/use tax and is informed that the jurisdiction(s) and amount of tax was calculated based on data provided by the buyer. Where permitted by jurisdictional rules, the buyer will be given the option to override the calculated jurisdiction prior to completion of the transaction.

Various embodiments assume that some, if not all, governments will allow for 3rd-party collection and reporting of sales/use tax on behalf of merchants. The process description that follows will assume that a 3rd-party is involved in this aspect. However, other embodiments provide that in the event that this is not the case, the merchant will take the role of the sales/use tax processor.

Once the payment-processing suite has received authorization from both the buyer and the buyer's (issuing) bank, the funds will be collected from the buyer and settled into the appropriate accounts. Where the STPS is operated by a third-party, the collected taxes can be settled into the STPS account, or alternatively, the collected taxes can be settled into the merchants account and the merchant will subsequently transfer the funds via the STPS to the various tax jurisdictions by way of settlement. In cases where the merchant is acting as the STPS, the collected taxes will be remitted into the selected merchant's account also. Additionally, transaction details are passed to the STPS for archiving and reporting. These details will include, among other items, data pertaining to the calculated tax jurisdiction, the version and issue dates of applied rules, any exceptions, overrides by buyer, etc.

Based on the rules and regulations of each collecting agency, the merchant (or the STPS on behalf of the merchant) will periodically remit the collected taxes (less any refunds) to the various collecting agencies. The STPS will also provide reports to the collecting agency, detailing the merchant-specific taxes collected, submitted, exceptions, overrides, etc.

As with any transaction, occasionally, there is a necessity to “reverse” a transaction and reimburse the buyer.

In these cases, the initial procedure for a transaction reversal will be much the same as is presently the case, either in an e-Commerce, or in a “bricks-and-mortar” transaction. The request will be initiated by the buyer and the original transaction details and identifier will be provided.

Once the refund request has been approved by the merchant, the pertinent details are passed to the payment processor and to the STPS. The original transaction data is retrieved and the STPS will calculate the refund rules for the transaction. For example, the STPS will review the corresponding tax rules to confirm that the transaction qualifies for a tax refund. Thereafter, assuming that a refund is qualified, it will establish whether tax funds are to be reimbursed from a holding account or from the merchant, whether a cash refund is to be solicited from the collecting agency, or whether a tax credit is to be applied for the merchant, etc. Thereafter, the payment processor and STPS exchange necessary sales/use tax data.

The payment processor then requests funds from the merchant and/or the STPS and the funds are reimbursed to the buyer. Necessary data pertaining to the reimbursement, reasons, etc. are archived by the payment processor and STPS as required.

Based on the rules and regulations of each collecting agency, the merchant (or the STPS) provides reports to the collecting agency, detailing the merchant-specific taxes reimbursed, reasons, exceptions, overrides, etc. Additionally, where permitted and appropriate, any reimbursements made by the merchant that included sales/use tax are deducted from any tax remittances that may be due.

FIG. 1 depicts a block diagram of a network system 100 in accordance with an embodiment of the present invention. In this figure, network 115 is any known type of computer network, including private networks or public networks such as the internet. While network 115 is shown in only one instance here; as known to those of skill in the art, network 115 can be implemented in multiple separate networks, or in the same public or private network system. Of course, any data or network communication described herein can be implemented using any known data communications means, such as via telephone modem, xDSL, fiber optic, wireless, etc., or public or private networks. These communications will include data pertaining to purchases and refunds, taxes, and other functions, as known in the art and/or as specifically described below.

Server 105 is shown communicating with tax rules database 110, and with client system 120 and purchasing commerce systems 125 via network 115. Server system 105 is a data processing system server, configured to communicate with multiple different client systems, including tax rules database 110, and with client system 120, network 115, purchasing commerce system 125, merchant system 130, Tax Jurisdictions/Authorities 135, and others.

Tax rules database 110 can be implemented in any known database and storage system, and it is understood that tax rules database 110 and server system 105 may be co-located or placed at different locations, may be integrated into a single data processing system, or be otherwise structured as known to those of skill in the art, so long as they are capable of together performing the functions described and claimed herein.

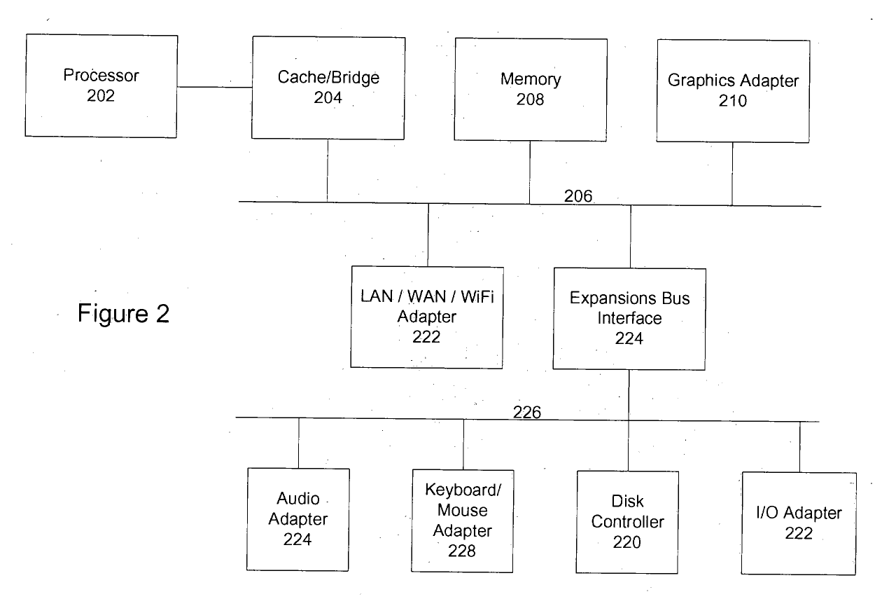

FIG. 2 depicts a data processing system in which a preferred embodiment of the present invention may be implemented, as the server system, the client system, or both. The data processing system depicted includes a processor 202 connected to a level two cache/bridge 204, which is connected in turn to a local system bus 206. Local system bus 206 may be, for example, a peripheral component interconnect (PCI) architecture bus. Also connected to local system bus in the depicted example are a main memory 208 and a graphics adapter 210.

Other peripherals, such as local area network (LAN)/Wide Area Network/Wireless (e.g. WiFi) adapter 212, may also be connected to local system bus 206. Expansion bus interface 214 connects local system bus 206 to input/output (I/O) bus 216. I/O bus 416 is connected to keyboard/mouse adapter 218, disk controller 220, and I/O adapter 222.

Also connected to I/O bus 216 in the example shown is audio adapter 224, to which speakers (not shown) may be connected for playing sounds. Keyboard/mouse adapter 418 provides a connection for a pointing device (not shown), such as a mouse, trackball, trackpointer, etc.

Those of ordinary skill in the art will appreciate that the hardware depicted in FIG. 2 may vary for particular. For example, other peripheral devices, such as an optical disk drive and the like, also may be used in addition or in place of the hardware depicted. The depicted example is provided for the purpose of explanation only and is not meant to imply architectural limitations with respect to the present invention.

A data processing system in accordance with a preferred embodiment of the present invention includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash., or a version of Solaris™, a product of Sun Microsystems located in Santa Clara, Calif., may be employed if suitably modified. The operating system is modified or created in accordance with the present invention as described. Further, a spreadsheet application such as Microsoft Excel™ can be used to implement certain aspects of the present invention.

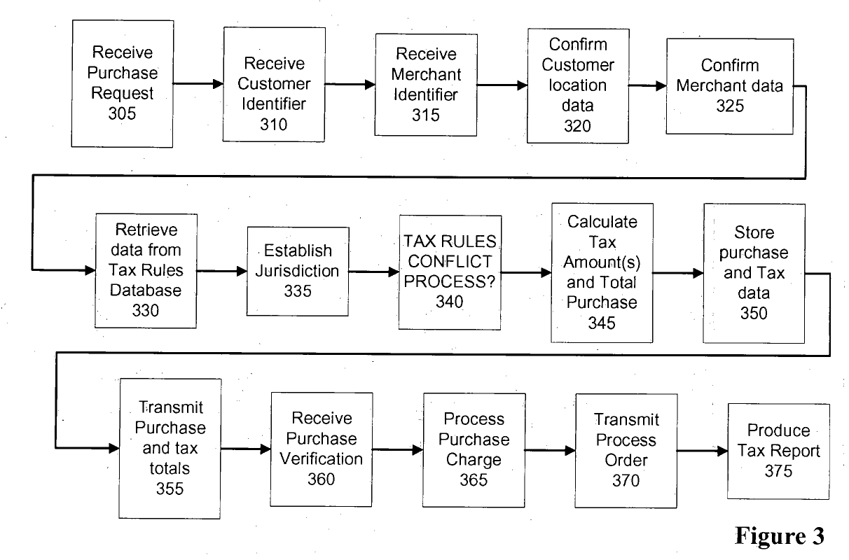

FIG. 3 depicts a flowchart of a sales process in accordance with a preferred embodiment. Here, a server system receives a purchase request from a client system (step 305). The purchase request will typically include a product indicator (or indicators in the case of multiple products), which the server will associate with a product price (or prices) and other product pricing details, such as shipping cost. The server system will also receive, from the client system, a customer identifier (step 310), which includes a customer taxing jurisdiction and preferably also includes customer shipping and billing information. Note that this information can be expressly requested from and entered by the customer, or can be loaded from a previously collected customer data, or can be determined after loading a “cookie” from the client system, or can be received or retrieved by other known means.

The server then receives a merchant identifier (step 315). The server will communicate with the client to confirm the customer billing, shipping and other location data (step 320). The server will confirm the merchant tax jurisdiction, “ship-from” location, and other merchant location data (step 325).

The server will then retrieve data from a tax rules database to determine the appropriate tax corresponding to the purchase request (step 330). From the tax rules, and the customer and merchant location information, the system will determine the taxing jurisdiction or jurisdictions (step 335). The server will also determine if a tax rules conflict exists, and whether to perform a tax rules conflict process (step 340), described below.

The server will then calculate a total purchase amount, including the purchase price, the taxes, and any shipping charges (step 345). The total purchase data, along with information as to which tax rules were applied, are stored by the server system (step 350).

The total purchase data, including tax data, is transmitted to the client system (step 355), and the server receives a purchase verification from the client system (step 360).

The server will then process a charge for the total purchase amount (step 365), and will transmit a command for the order to be processed (step 370).

The server will produce a tax report for the corresponding taxing jurisdiction(s), indicating at least the amount of the purchase and the tax amount charges as well as other data that is permitted by applicable laws and regulations (step 375). The tax report can be transmitted to the taxing jurisdiction(s), and can include a tax remittance. This report may be transmitted real-time, at the time the transaction is completed, or may be sent in a individually or in batch at a later time.

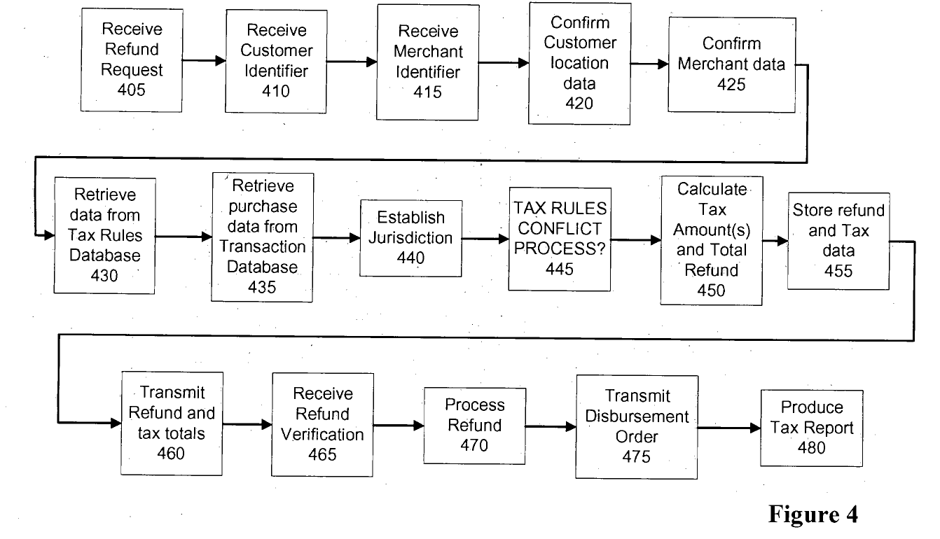

FIG. 4 depicts a refund process in accordance with a preferred embodiment. Here, a server system receives a refund request from a client system (step 405). The refund request will typically include transaction identifier associated with the original sales transaction, a product indicator (or indicators in the case of multiple products), which the server will associate with a product price (or prices) and other product pricing details, such as the monetary amount associated with the product(s) that is to be refunded, shipping cost, etc. The server system will also receive, from the client system, a customer identifier (step 410), which includes a customer taxing jurisdiction(s) and preferably also includes customer shipping and billing information. Note that this information can be expressly requested from and entered by the customer, or can be loaded from a previously collected customer data, or can be determined after loading a “cookie” from the client system, or can be received or retrieved by other known means.

The server then receives a merchant identifier (step 415). The server will communicate with the client to confirm the customer billing, shipping and other location data (step 420). The server will confirm the merchant tax jurisdiction, “ship-from” location, and other merchant location data (step 425).

The server will then retrieve data from a tax rules database to determine the appropriate tax(es) corresponding to the refund request (step 430). The system will then retrieve purchase data, for the purchase to be refunded, from the transaction database (step 435).

From the tax rules, product information and the customer and merchant location information, the system will determine the taxing jurisdiction or jurisdictions (step 440). The server will also determine if a tax rules conflict exists, and whether to perform a tax rules conflict process (step 445), described below.

The server will then calculate a total refund amount, including the refund price, the taxes (if any), and any shipping charges (step 450). The total refund data, along with information as to which tax rules were applied, are stored by the server system (step 455).

The total refund data, including tax data, is transmitted to the client system (step 460), and the server receives a refund verification from the client system (step 465).

The server will then process a credit for the total refund amount (step 470), and will transmit a command for the refund to be disbursed (step 475).

The server will produce a tax report for the corresponding taxing jurisdiction(s), indicating at least the amount(s) of the refund and the tax amount refunded as well as other data that is permitted by applicable laws and regulations (step 480). The tax report can be transmitted to the taxing jurisdiction(s), and can include a tax remittance. This report may be transmitted real-time, at the time the transaction is completed, or may be sent in a individually or in batch at a later time.

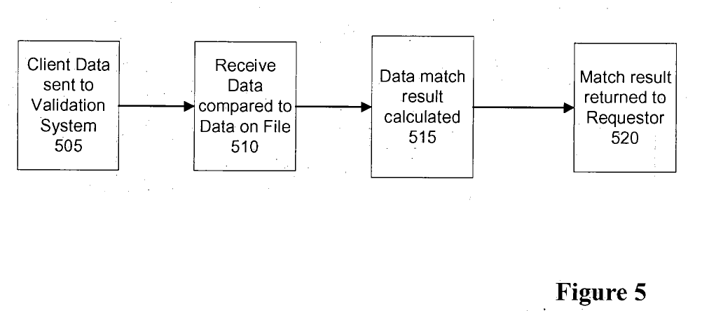

FIG. 5 depicts a flowchart of a client validation process in accordance with a preferred embodiment of the present invention. First, the client system sends, and validation system receives, client data that preferably includes customer location data such as ship-to address, bill-to address, and the customer's nationality and residency (step 505).

The server will then compare the client data received against client data on file (step 510), and a data match result is calculated (step 515). In a preferred embodiment, the result format is “aaa-bbb-ccc-ddd.”, where “aaa” is the percent match of the claimed residency, “bbb” is the percent match of the billing address, “ccc” is the percent match of the ship-to address, and “ddd” is the serial number.

Finally, the match result is returned to the requesting system (step 520).

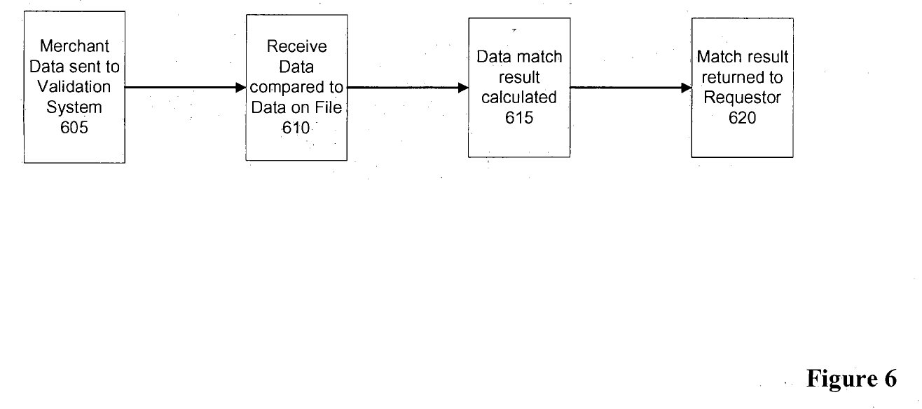

FIG. 6 depicts a flowchart of a merchant validation process in accordance with a preferred embodiment of the present invention. First, the client system sends, and validation system receives, merchant data that preferably includes merchant location data such as ship-from address, bill-from address, the merchant's corporate residency, and DUNS, etc. (step 605).

The server will then compare the merchant data received against merchant data on file (step 610), and a data match result is calculated (step 615). In a preferred embodiment, the result format is “aaa-bbb-ccc-ddd.”, where “aaa” is the percent match of the claimed residency, “bbb” is the percent match of the bill-from address, “ccc” is the percent match of the ship-from address, and “ddd” is the serial number.

Finally, the match result is returned to the requesting system (step 620).

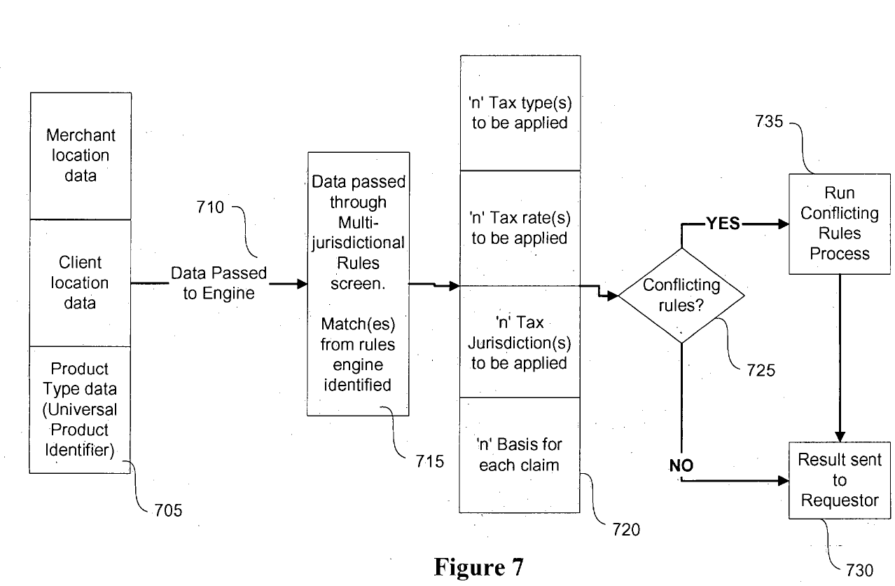

FIG. 7 depicts a data/logic flow for establishing the tax jurisdiction(s) that has/have a claim over a given transaction, as well as the basis/bases for such claim. The transaction data that is needed to establish the appropriate tax jurisdiction(s), such as merchant residence & location data, buyer residence & location data, product types (such as Universal Product Identifiers) is assembled (step 705). This data is then passed to a process (or “Engine”) for analysis (step 710). The engine, or process, systematically compares all of the received data with the various tax rules that are held in the database (step 715). Based on the rules, the engine may determine that there are multiple jurisdictions (or ‘n’ jurisdictions) that have some type of tax rights to the transaction. Similarly, the engine may determine that there are multiple tax types (or ‘n’ Tax types) that are to be applied. As an example, these types could include a “Sales tax”, a “Consumption Tax”, a “Product tax” (such as tobacco products, pharmaceuticals, etc.) and the like. Equally, if multiple tax types and/or jurisdictions are determined, the system may determine that multiple Tax rates (or ‘n’ tax rates) are to be applied to the transaction. For each of the taxes that are to be applied to the transaction, a basis identifier is assigned. There are ‘n’ Bases assigned corresponding to the number of unique taxes to be collected. These results are formatted and collated by the engine (step 720). The system will then determine whether there is a tax rules conflict, in which case it will run the process for handling rules conflicts (step 735). If no conflicts have been determined the results 720 are passed back to the process that made the initial request.

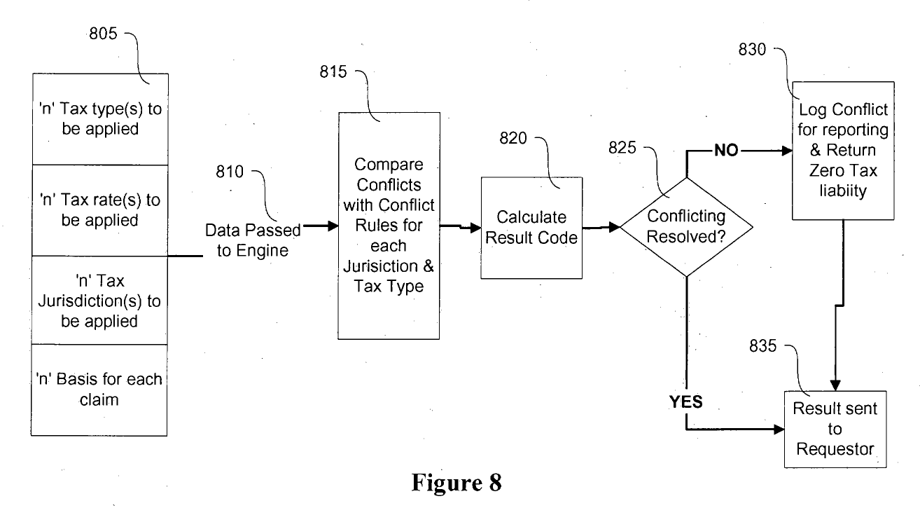

FIG. 8 depicts a data/logic flow for resolving conflicting rules pertaining to the establishment of jurisdiction(s) that has/have a claim over a given transaction, as well as the basis/bases for such claim. All of the data pertaining to the Tax jurisdictions, Tax rates, Tax types and Tax bases (705) are passed to the process (805). These are in turn passed to the conflict resolution process (step 810). The data is compared with the tax rules in the database that, for each jurisdiction, provide rules for handling conflicting claims and disputes. For example, certain jurisdictions may have rules that state that if a transaction is potentially liable for both a sales/use tax and a consumption tax based on the location data of the buyer, only one of the two ought to be applied (step 815). Based on the conflict rules pertaining to the specific details of 805 a result code is calculated (step 820). The result code is analyzed to confirm whether the conflict has been resolved (step 825). For any unresolved rule conflicts, a zero tax liability is returned and a log entry for reporting is generated accordingly (step 830). The results are returned to the requesting process (step 835).

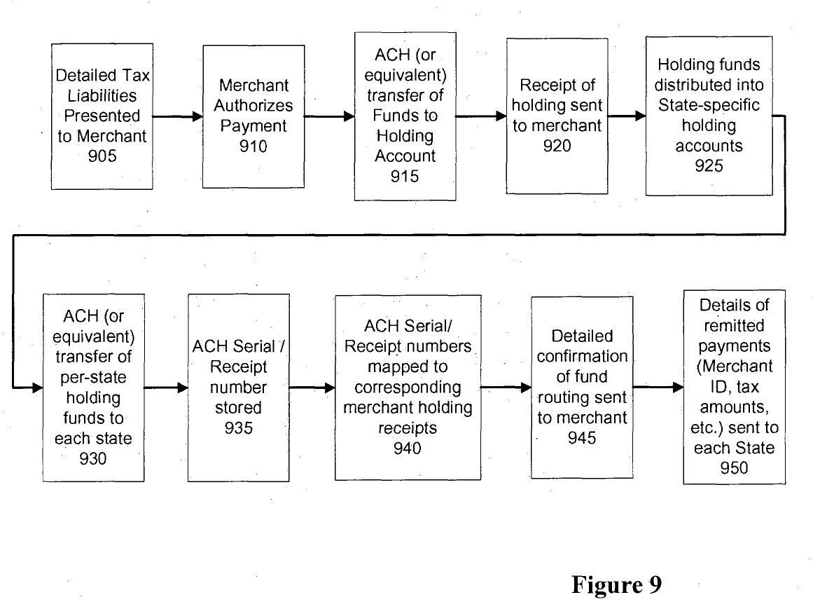

FIG. 9 depicts a tax settlement process in accordance with a preferred embodiment of the present invention. Here, a detailed statement, paper or electronic, of tax liabilities is presented to the merchant (step 905). The merchant authorizes payment (step 910).

An automatic clearing house (ACH) funds transfer, or other type of funds transfer, is used to transfer funds from the merchant to a holding account (step 915), and a receipt is sent to the merchant (step 920). The holding funds from the merchant are then distributed into state-specific holding accounts, according to the states to which the tax is owed (step 925).

The state specific funds are transferred to each state (step 930), and an ACH serial/receipt number (or other transfer receipt) is stored (step 935). The receipt numbers are then mapped to the corresponding merchant (step 940), and a detailed confirmation of the fund routing is sent to the merchants (step 945). Finally, details of remitted payments are sent to each state (step 950).

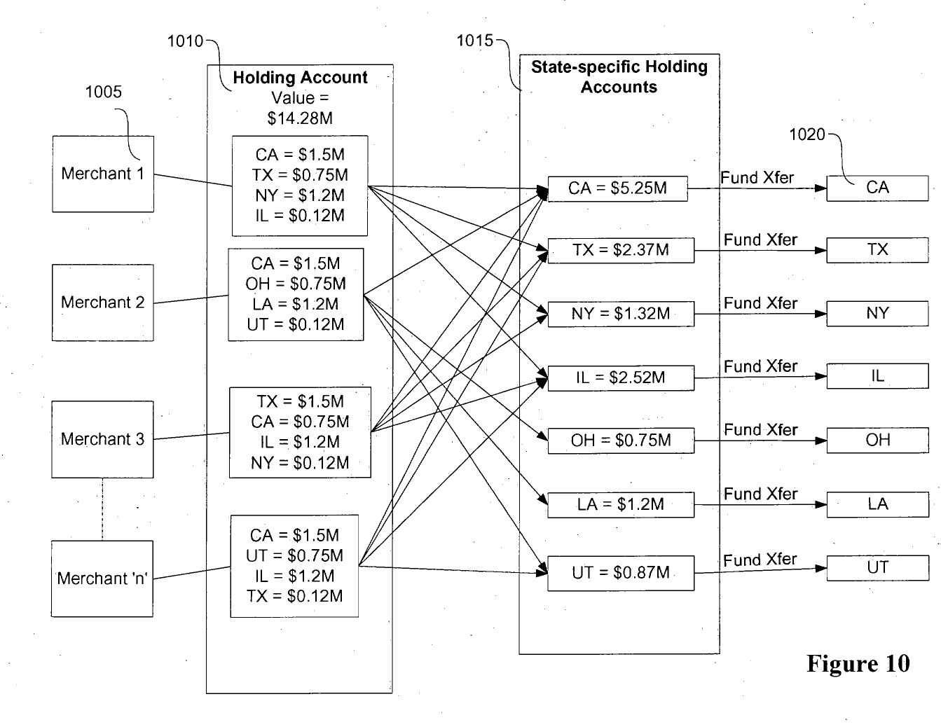

FIG. 10 depicts a block diagram of a sample tax settlement in accordance with the preferred embodiment. Here the merchants 1005 transmit their collected tax funds into merchant-specific holding accounts 1010. These funds are segregated and moved into state-specific holding accounts 1015. Finally, the state-specific funds are transferred to each state 1020.

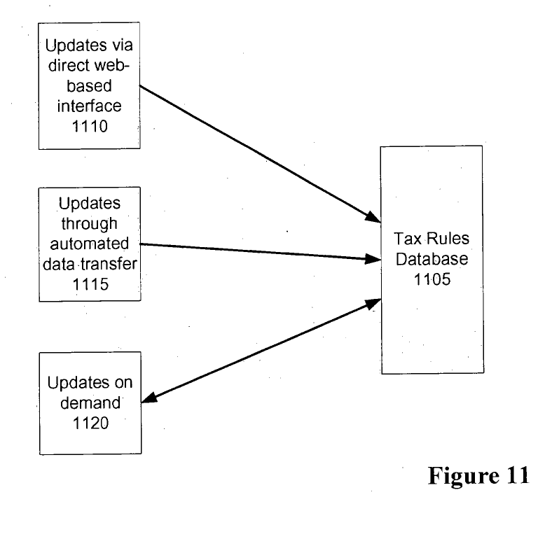

FIG. 11 is a block diagram of means of updating a tax rules database in accordance with a preferred embodiment of the present invention. Here, tax rules database 1105 can be updated in multiple ways. First, it can be updated via a direct web-based interface 1110. Updates can also be made via an automated data transfer 1115. Further, updates can be made on demand by authorized users and systems 1120.

Those skilled in the art will recognize that, for simplicity and clarity, the full structure and operation of all systems suitable for use with the present invention is not being depicted or described herein. Instead, only so much of a system and network as is unique to the present invention or necessary for an understanding of the present invention is depicted and described. The remainder of the construction and operation of the disclosed systems may conform to any of the various current implementations and practices known in the art.

It is important to note that while the present invention has been described in the context of a fully functional system, those skilled in the art will appreciate that at least portions of the mechanism of the present invention are capable of being distributed in the form of a instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

What is claimed is:

1. A method for calculating tax on a transaction comprising:
receiving transaction information including at least customer location data, merchant location data, and price data;
retrieving tax rules data;
determining at least one tax jurisdiction according to the transaction information and the tax rules data;
determining the transaction tax amounts for each of the tax jurisdictions according to the transaction information and tax rules data; and
transmitting the transaction tax amounts.

2. The method of claim 1, further comprising determining if the tax rules data indicates a tax conflict and resolving the tax conflict.

3. The method of claim 1, further comprising completing a purchase transaction according to the transaction information and the transaction tax amounts.

4. The method of claim 1, wherein the customer location data and merchant location data indicate different taxing jurisdictions.

5. The method of claim 1, further comprising processing a refund transaction according to the transaction information and the transaction tax amounts.

6. The method of claim 1, further comprising verifying at least a portion of the transaction data.

7. The method of claim 1, further comprising processing a transaction to collect taxes according to the transaction tax amounts and to disburse the taxes to the tax jurisdictions.

8. A data processing system having at least a processor and accessible memory, comprising:
means for receiving transaction information including at least customer location data, merchant location data, and price data;
means for retrieving tax rules data;
means for determining at least one tax jurisdiction according to the transaction information and the tax rules data;
means for determining the transaction tax amounts for each of the tax jurisdictions according to the transaction information and tax rules data; and
means for transmitting the transaction tax amounts.

9. The data processing system of claim 8, further comprising means for determining if the tax rules data indicates a tax conflict and resolving the tax conflict.

10. The data processing system of claim 8, further comprising means for completing a purchase transaction according to the transaction information and the transaction tax amounts.

11. The data processing system of claim 8, wherein the customer location data and merchant location data indicate different taxing jurisdictions.

12. The data processing system of claim 8 further comprising means for processing a refund transaction according to the transaction information and the transaction tax amounts.

13. The data processing system of claim 8, further comprising means for verifying at least a portion of the transaction data.

14. The data processing system of claim 8, further comprising means for processing a transaction to collect taxes according to the transaction tax amounts and to disburse the taxes to the tax jurisdictions.

15. A computer program product tangibly embodied in a computer-readable medium, comprising:
instructions for receiving transaction information including at least customer location data, merchant location data, and price data;
instructions for retrieving tax rules data;
instructions for determining at least one tax jurisdiction according to the transaction information and the tax rules data;
instructions for determining the transaction tax amounts for each of the tax jurisdictions according to the transaction information and tax rules data; and
instructions for transmitting the transaction tax amounts.

16. The computer program product of claim 15, further comprising instructions for determining if the tax rules data indicates a tax conflict and resolving the tax conflict.

17. The computer program product of claim 15, further comprising instructions for completing a purchase transaction according to the transaction information and the transaction tax amounts.

18. The computer program product of claim 15, wherein the customer location data and merchant location data indicate different taxing jurisdictions.

19. The computer program product of claim 15, further comprising instructions for processing a refund transaction according to the transaction information and the transaction tax amounts.

20. The computer program product of claim 15, further comprising instructions for verifying at least a portion of the transaction data.

21. The computer program product of claim 15, further comprising instructions for processing a transaction to collect taxes according to the transaction tax amounts and to disburse the taxes to the tax jurisdictions.
